(19) United States
(12) Patent Application Publication
(10) Pub. No.: US 2012/0185777 A1
(43) Pub. Date: Jul. 19, 2012

(54) Method and apparatus for facilitating personality profiling

(76) Inventor: Abhijit Banerjee, Stanmore (GB)

(21) Appl. No.: 12/930,705

(22) Filed: Jan. 14, 2011

(51) Int. Cl. G06F 3/048; G06F 15/16

(52) U.S. Cl. 715/738; 715/833

(57) ABSTRACT

Described are methods and apparatus for facilitating reviewing of a person's personality using a graphical user interface. The graphical user interface comprises a plurality of adjustable graphical elements. Each of the adjustable graphical elements represents a plurality of personality characteristics, and each of the adjustable graphical elements is adjustable to one of a plurality of different positions. Each of the positions corresponds to a value of the respective plurality of personality characteristics.

### FIELD

Embodiments described herein relate generally to methods and apparatus for personality profiling. They have particular, but not exclusive, application in the field of employee recruitment and development.

### BACKGROUND

Personality profiling has become an increasingly popular tool for organisations, with applications spanning the entire employment cycle. For example, it is an efficient and proven means of narrowing down a list of candidates to those that are best suited for a job. Modern technologies, including the Internet, offer new capabilities for the delivery and application of personality profiling. It is desirable to provide methods and apparatus for facilitating personality profiling that take advantage of such capabilities.

### SUMMARY

Embodiments described herein are directed to methods and apparatus for facilitating reviewing of a person's personality using a graphical user interface. The graphical user interface comprises a plurality of adjustable graphical elements. Each of the adjustable graphical elements represents a plurality of personality characteristics, and each of the adjustable graphical elements is adjustable to one of a plurality of different positions. Each of the positions corresponds to a value of the respective plurality of personality characteristics.

Embodiments described herein are also directed to methods and apparatus for facilitating comparing of personality profiles. Personality profiles are defined by a plurality of data values. Each of data values represents a plurality of personality characteristics. Data values of first and second ones of the personality profiles are processed to obtain an overall similarity score, by determining the differences between respective data values of the first and second personality profiles.

### BRIEF DESCRIPTION OF THE DRAWINGS

Various embodiments are described in detail below with reference to accompanying drawings, in which:

FIG. 1 is a schematic diagram of a system for facilitating personality profiling according to an embodiment.

FIG. 2 is a flow diagram illustrating a method of creating a personality profile for a person according to an embodiment.

FIG. 3 illustrates a screen of a graphical user interface for creating a personality profile according to the method of FIG. 2.

FIGS. 4A and 4B illustrate screens of a graphical user interface for reviewing and comparing personality profiles according to an embodiment.

FIG. 5 illustrates a screen of a graphical user interface for reviewing and comparing personality profiles according to another embodiment.

FIG. 6 illustrates a screen of a graphical user interface for reviewing and comparing personality profiles according to yet another embodiment.

FIG. 7 is a diagram showing how a similarity between personality profiles can be determined according to an embodiment.

FIG. 8 is a flow diagram illustrating a method of determining the similarity between personality profiles according to an embodiment.

FIG. 9 is a flow diagram illustrating a method of creating a job listing according to an embodiment.

FIG. 10 is a screen of a graphical user interface for specifying details during job listing creation according to the method of FIG. 9.

FIG. 11 is a screen of a graphical user interface for specifying skill and experience requirements during job listing creation according to the method of FIG. 9.

FIG. 12 is a flow diagram illustrating a method of applying for a listed job according to an embodiment.

FIG. 13 is a screen of a graphical user interface for reviewing and comparing personality profiles of job candidates according to an embodiment.

FIG. 14 is a screen of a graphical user interface for reviewing and comparing personality profiles of job candidates according to another embodiment.

FIG. 15 is a flow diagram illustrating a method of determining a user's ability to judge people's personalities according to an embodiment.

FIG. 16 is a screen of a graphical user interface for suggesting characteristics according to an embodiment.

FIG. 17 illustrates a screen of a graphical user interface for reviewing and comparing personality profiles according to another embodiment.

While multiple embodiments are disclosed herein, still other embodiments will become apparent to those skilled in the art from the following detailed description, which describes illustrative embodiments. As will be realized by those of ordinary skill in the art upon reading the following disclosure, embodiments are capable of modifications in various aspects, all without departing from the spirit and scope of the present invention as defined in the appended claims. Accordingly, the drawings and detailed description are to be regarded as illustrative in nature and not restrictive.

### DETAILED DESCRIPTION OF EMBODIMENTS

In the detailed description that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

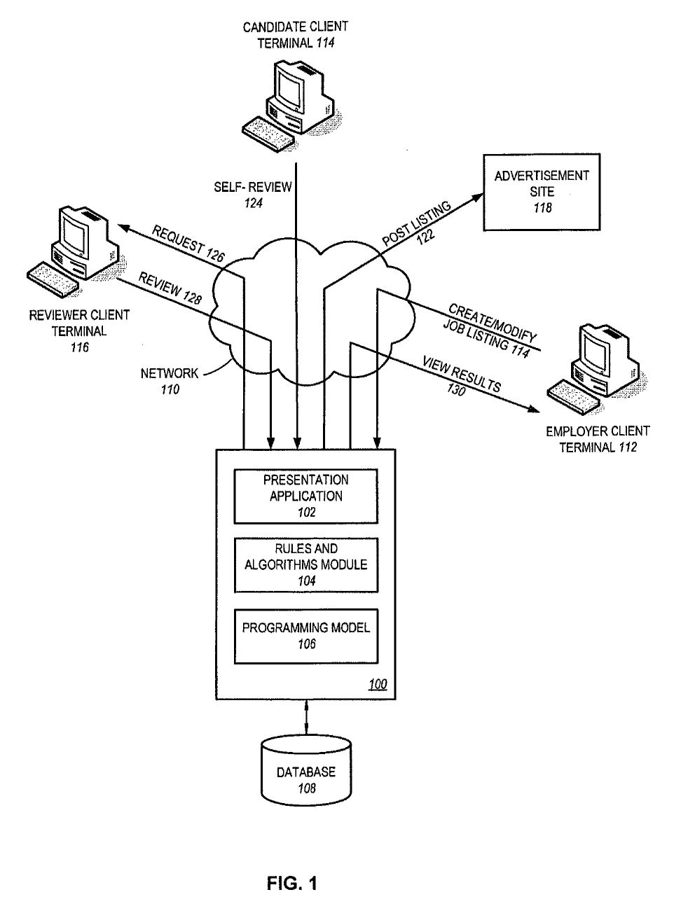

FIG. 1 schematically depicts a system 100 for facilitating personality profiling according to an embodiment. The system 100 comprises a presentation application 102, which serves as the initial point of contact, via network 110, for client terminals 112, 114, 116. The presentation application 102 can call upon, and interface with, the rules and algorithms module 104, which enables personality profiles to be compared, as will be described later. The rules and algorithms module 104 relies on a programming model 106, such as an object oriented programming model, that is populated using data stored in database 108. The presentation application 102 can comprise, for example, a web server.

A web server is a software component that responds to a hypertext transfer protocol (HTTP) request with an HTTP reply. As illustrative examples, the web server may be, without limitation, an Apache HTTP Server, an Apache Tomcat, a Microsoft Internet Information Server, a JBoss Application Server, a WebLogic Application Server, or a Sun Java System Web Server. The web server may serve content such as hypertext markup language (HTML), extendable markup language (XML), documents, videos, images, multimedia features, graphical user interfaces, or any combination thereof.

The presentation application 102, rules and algorithms module 104, and programming model 106 may be implemented using any suitable hardware, such as a processor and associated instruction memory storing the code operable to provide the services of the above-mentioned applications. The data in the database 108 can be stored in data tables and retrieved by the presentation application 102 when processing is required to convert the source data via the rules and algorithms module 104 to provide an end result to a user of the client terminals 112, 114, 116. The database 108 may be provided as a separate device (as shown) or as part of system 100. For example, the database may comprise a relational database where the data is represented in logic via object relational mappings to object orientated data objects stored in memory.

Examples of relational databases include Oracle, Microsoft SQL Server and MySQL. The front end display of the data may occur via the use of hypertext mark-up language. The client terminals 112, 114, 116 can include a web browser with associated memory. Other client terminal applications will be known to the skilled person and may also be provided. Again, the web browser and memory may be provided on any suitable hardware, such as a computer with processor and associated instruction and data memories. A network interface is also provided for connecting to the network 110.

In use, presentation application 102 provides a graphical user interface which an employer using client terminal 112 can use to create (and/or modify) a job listing. In the field of employee recruitment and development, for example, when an employer wishes to advertise a particular job, in order to identify candidates who appear to be suitable for a particular job that is being filled, the employer (or recruitment agent, as the case may be) may wish to obtain information not only about the skills and qualifications of the potential candidates, but also about their personalities. The job listing creation process will be described in due course. The job listing can be posted 122 to a job advertisement site 118 (which may be the web site of the employer or a third-party web site), stored locally or otherwise distributed. A potential candidate using client terminal 114 can search the job advertisement site and obtain search results (not shown), including the listed job. Searching techniques will be familiar to one skilled in the art.

The job listing created by the employer using system 100 can include a universal resource locator (URL) or other identifier of the system 100. In an embodiment, job listing creation generates two URLs, one enabling a potential candidate to connect to the system 100 in order to apply for the job and provide a self-review, and another enabling reviewers to connect to the system 100 in order to review a candidate. The candidate can then apply for the job, including creating a personality profile for himself (self-review 124). The candidate may also be asked to provide documents such as a CV, as well as a reference from a peer/colleague. For example, the system 100 can send an electronic request 126, such as an email including the URL or other identifier of the system 100, that the reviewer can read and respond to using client terminal 116. The reviewer then reviews 124 the candidate, including creating a personality profile for the candidate. It will be understood that several reviewers may be asked to provide a review. It will also be understood that, where candidate and/or reviewer are registered users of the system 100, the process can make use of existing reviews. The information provided by the reviewers is stored on the database 108, for subsequent processing. The results of the processing can be viewed 130 by the employer using client terminal 112.

The operation of the system mentioned above, particularly with regard to the application of employee recruitment, will now be described in greater detail.

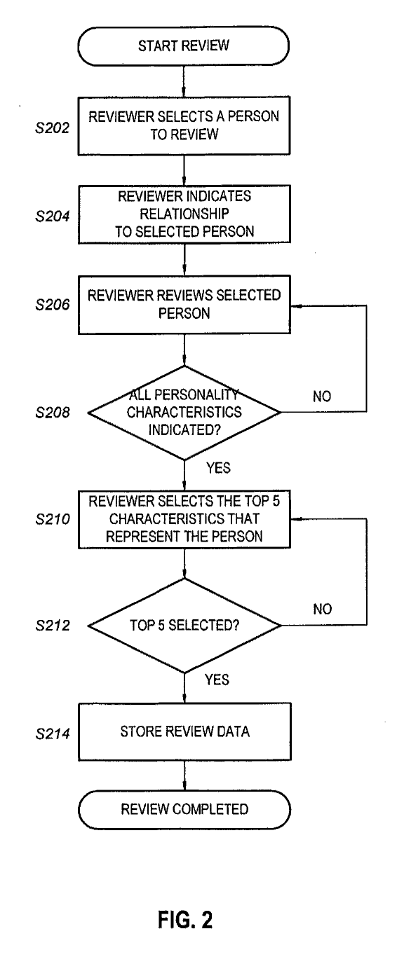

FIG. 2 shows an embodiment of a method of creating a personality profile for a person, encompassing both the self-review and the peer/colleague review. It will be appreciated that reviewers may be required to register with the system 100 prior to performing a review, though this is not essential. The skilled reader will be familiar with different registration and log-in methods and so these are not described here.

In step S202, the reviewer selects a person to review. For example, in the case of self-review, the reviewer indicates that they are reviewing themselves. In the case of a peer/colleague review, as explained above, the review process can be initiated by a request sent from system 100 in response to a candidate applying for a job.

In step S204, the reviewer indicates their relationship to the selected person. Exemplary options comprise “Person is a co-worker”, “I've done business with the person”, “I went to school/college with the person”, “I'm friends with the person” and “Person is in my family.” The indication may be given by checking boxes, selecting from a list, entering text, or any combination thereof. In an embodiment, the relationship information also includes information about the length of time that the person is known to the reviewer, such as “First Impressions”, “0-2 Years”, “2-5 Years”, “5-20 Years” and “20+ Years”.

In step S206, the reviewer then creates a personality profile for the selected person. Details of the process are set out in greater detail below. In general terms, the reviewer selects personality characteristics that describe the selected person (step S208). The personality characteristics may be predetermined by the system 100 or may be specific to the employer and/or specific to the listed job. The reviewer also selects one or more top personality characteristics that best represents the selected individual (steps S210 and S212). In an embodiment, the reviewer selects the top five personality characteristics. This completes the review and, in step S214, the data is stored in database 106.

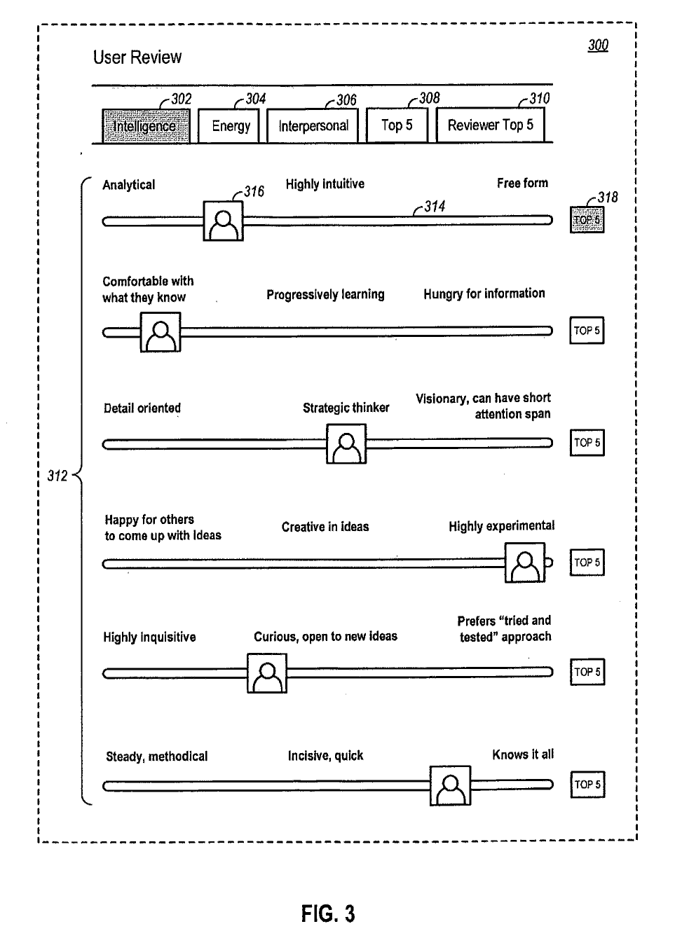

FIG. 3 illustrates a screen 300 of a graphical user interface (GUI) provided by the personality profiling system for creating a personality profile. The GUI can be in the form of an interactive web site, for example. The interface screen 300 comprises a set of tabs 302, 304, 306, 308, 310. As shown in FIG. 3, the “Intelligence” tab 302 is currently selected. For each tab 302, 304, 306 there is a set of adjustable graphical elements. In the embodiment shown in FIG. 3, the adjustable graphical elements comprise graphical sliders 312 each representing a set of three related personality characteristics. It will be apparent to the skilled person that other types of adjustable graphical elements could be used and that fewer or more than three personality characteristics could be represented by one, some or all of the adjustable graphical elements 312. Similarly, although six graphical sliders are shown in FIG. 3, different numbers of graphical sliders can be shown instead. Each graphical slider comprises a track 314 and a slider button 316 or other element.

In an embodiment, the interface screen 300 does not display any values (which may be quantitative and/or qualitative) corresponding to the different positions that the graphical sliders can take. Thus the graphical elements provide a relative measure between at least two personality characteristics that are selected to be “neutral” rather than positive/negative, and not a score on a single scale. This encourages reviewers to provide an authentic assessment of the reviewee, as reviewers are not trying to “enhance” a score.

Also shown in FIG. 3 are the graphical elements 318, which enable selection of those personality characteristic considered to be highly ranked personality characteristics. In doing so, and by adding a weighting to the selected personality characteristics (which can be altered by the employer to suit their emphasis, i.e. the job), it is expected that a closer match between any two reviewed individuals can be obtained. The “Top 5” and “Reviewer Top 5” tabs 308, 310 provide an indication of the personality characteristic selected by the user himself and those selected by one or more other reviewers, respectively. It will be apparent that tabs 308, 310 need not be shown where a peer/colleague is reviewing a candidate.

In one embodiment, the interface comprises twenty adjustable graphical elements grouped into the three different personality areas, namely Intelligence, Energy and Interpersonal. For example, the Intelligence area can comprise six adjustable graphical elements, with the Energy and Interpersonal areas each having seven adjustable graphical elements. In one embodiment, for each adjustable graphical element there is a set of three related personality characteristics (or levels of opinion), for example “Analytical”, “Highly Intuitive” and “Free Form”. A reviewer selects a position on a corresponding graphical slider that they think best represents the individual they are reviewing. In one embodiment, the length of the slider corresponds to a numerical scale ranging between 0 and 200, where a value of “0” indicates a position of “Analytical”, a value of “100” indicates “Highly Intuitive”, and a value “200” indicates “Free Form”. In this way, a value of “50” would mean that the reviewer considers the person they are reviewing to be exactly between “Analytical” and “Highly Intuitive”. AS described above, in certain graphical user interface does not show the values thereby enabling more authentic review. Exemplary personality characteristics are given in the tables below.

TABLE 1
Intelligence

| Characteristic 1 | Characteristic 2 | Characteristic 3 |
|---|---|---|
| Analytical | Highly intuitive | Free form |
| Comfortable with | Progressively learning | Hungry for information |
| what they know | | |
| Detail oriented | Strategic thinker | Visionary, can have short |
| | | attention span |
| Happy for others to | Creative in ideas | Highly experimental |
| come up with ideas | | |
| Highly inquisitive | Curious, open to new | Prefers “tried and tested” |
| | ideas | approach |
| Steady, methodical | Incisive, quick | Knows it all |

TABLE 2
Energy

| Characteristic 1 | Characteristic 2 | Characteristic 3 |
|---|---|---|
| Delegates | Conscientious | Workaholic |
| Happy with where | Quite ambitious | Extremely ambitious |
| they are | | |
| Passive, calm | Adventurous | Aggressive |
| Relaxed, can be shy | Enthusiastic | Highly extrovert, can be |
| | | extreme |
| Risk averse | Measured risk taker | Enjoys high stakes |
| Steady interest | Passionate about key | Obsessive |
| | interests | |
| Steady pace | Short bursts of high | Persistent, highly resilient |
| | energy | |

TABLE 3
Interpersonal

| Characteristic 1 | Characteristic 2 | Characteristic 3 |
|---|---|---|
| A few close friends | Sociable | Knows everyone |
| Consensual | Engaging, inspiring | Forceful, dominant |
| Focused on self | Caring, but self first | Selfless |
| Mild mannered | Self assured | Extremely confident |
| Says anything to | Honest, some | Too honest, highly |
| get things done | white lies | principled |
| Serious, professional | Fun, entertaining | Daring, provocative, |
| | | edgy |
| Thick skinned | Forgiving | Retaliatory |

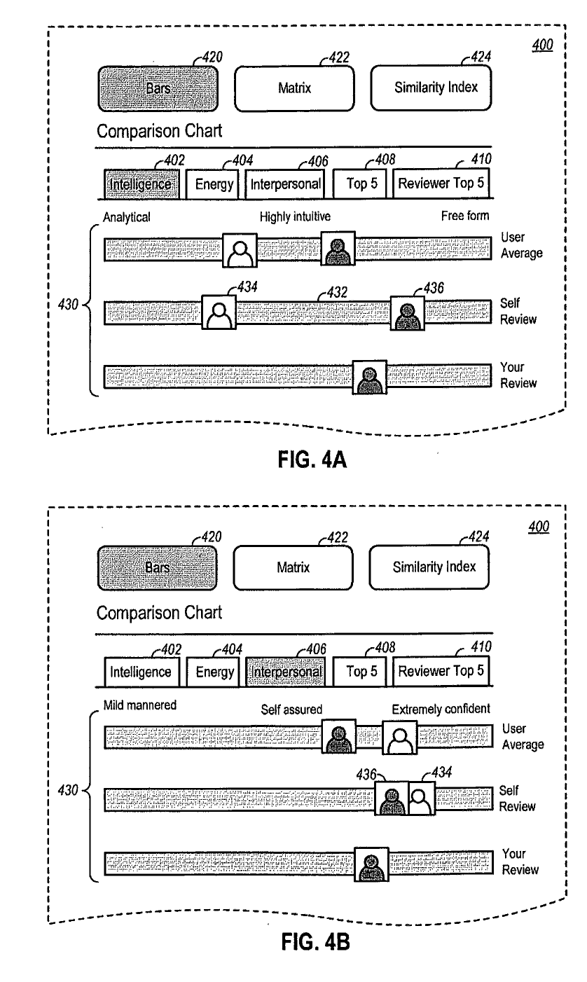

FIGS. 4A to 6 illustrate different screens of a graphical user for reviewing and comparing personality profiles, in accordance with various embodiments.

In embodiments described herein, there are three ways in which the comparison of personality profiles can be visually presented, namely in bar form, matrix form, and as an overall similarity score. Selectable graphical elements 420, 422, 424, 520, 522, 524, 620, 622, 624 in FIGS. 4A to 6 correspond to these choices.

In FIGS. 4A and 4B, the bar form is shown. As in FIG. 3, there are tabs 402, 404, 406, 408, 410 for selecting the different personality areas and “Top 5” options. In FIG. 4A, the values corresponding to a set of three related personality characteristics (“Analytical”, “Highly intuitive”, “Free form”) from the “Intelligence” personality area is shown for two individuals 434, 436. In this embodiment, the selected personality characteristics are shown as three individual graphical elements 430 corresponding to “user average”, “self-review” and “your review”. The “user average” graphic indicates for each individual 434, 436 an average value for the personality characteristics based on all reviews of that individual, including the individual's own review, the “self review” graphic indicates for each individual 434, 436 the value for the personality characteristic based on the user's review of themselves, and the “your review” graphic represents a user's review of another user (e.g. the review by user 434 of user 436 for that personality characteristic). As can be seen, user 434 considers his personality to be somewhere between “Analytical” and “Highly Intuitive”, whereas user 436 considers his personality to be somewhere between “Highly Intuitive” and “Free form”. User 436 considers that he is more “Free form” compared to what other users have indicated. Similarly, there is a slight divergence between how user 434 rates himself and how other users rate him. FIG. 4B provides an example of an “interpersonal” personality characteristic.

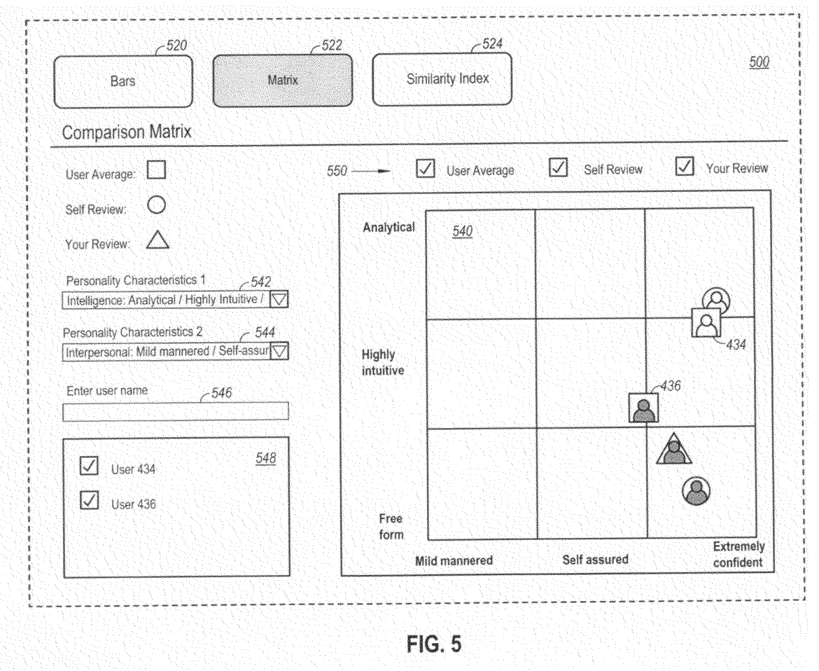

FIG. 5 illustrates the matrix form, as indicated by selection of element 522 from among elements 520, 522, 524. The matrix 540 has as its y-axis the “intelligence” personality characteristic and values shown for users 434, 436 in FIG. 4A and as its x-axis the “interpersonal” personality characteristic and values shown in FIG. 4B. Different personality characteristics can be selected from drop-down menus 542, 544. Individuals can be searched using a name field 546, and selected (or deselected) using panel 548. The different review values 550 can similarly be selected or deselected. The matrix 540 provides for a quick comparison of two (sets) of personality characteristics. In this case, it can be seen that other reviewers consider users 434, 436 to be highly intuitive and also confident.

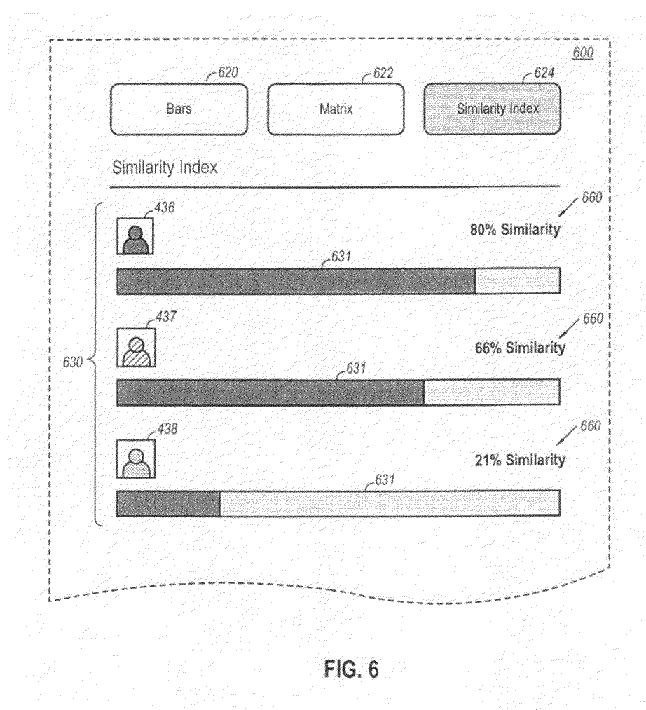

In FIG. 6, an overall similarity score between user 434 and each of users 436, 437, 438 is shown in a screen 600 of the graphical user interface. Each of the graphical elements 630 comprise an icon 436, 437, 438, such as a use image, a bar graphic 631, and a similarity score 660. The users are shown according to how similar their personality profile is to that of the user 434.

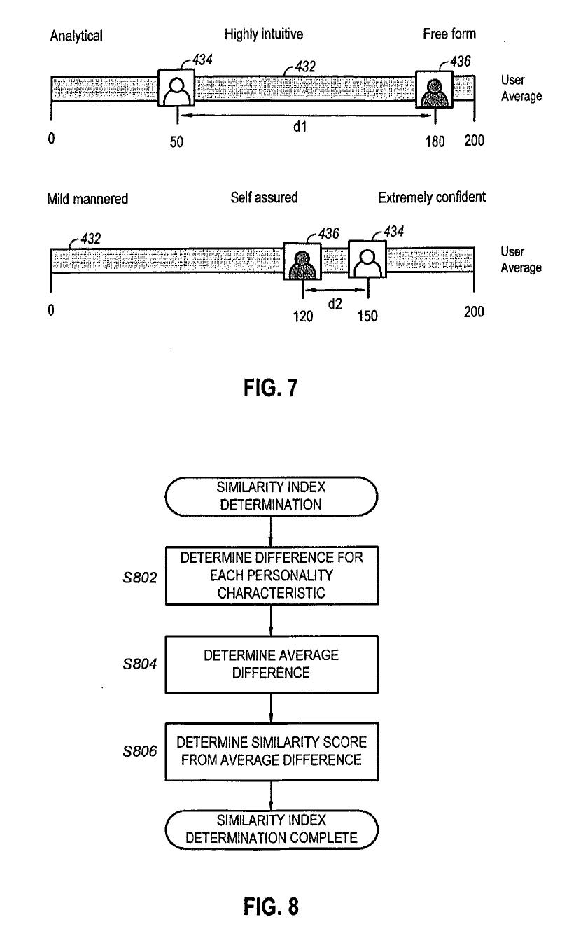

In one embodiment, the similarity scores are calculated as shown by FIGS. 7 and 8. FIG. 7 shows the user average graphics for the two personality characteristics for users 434, 436 shown in FIGS. 4A and 4B. The bars are scored from 0 to 200, as explained previously, though it will be appreciated that other values could equally be used. In step S802, the absolute difference between the values for the personality characteristics for individuals 434, 436 is determined. Thus, for example, the difference for the shown “Intelligence” personality characteristic is 130, and the difference for the shown “Interpersonal” personality characteristic is 30. The values are then normalised by dividing by 200, to give to 0.65 and 0.15, respectively. Then the average difference for the personality characteristics is determined (step S804), by adding the difference values and dividing the obtained value by the number of personality characteristics that are being taken into account (in this example, two). Thus the average difference is 0.4 (or 40%). In step S806, the similarity is determined from the average difference value, to give 0.6 (or 60%) similarity in respect of these two sets personality characteristics. The scores shown in FIG. 6 are used only by way of example. In practice, the similarity score is usually not less than 60%.

As explained previously, rather than treat the reviews across all personality characteristics equally, reviewers are asked to select what they consider to be the one or more personality characteristics that best represent the person being reviewed. Thus, in one embodiment, the similarity score takes into account the “Top 5” selections. For example, if the “Intelligence” personality characteristic that is shown in FIG. 7 is a highly ranked (e.g. “Top 5”) personality characteristic for user 434 or a “Top 5” for user 436, then the difference value d1 can be weighted by a first weighting value, for example 1.4. Alternatively, if the “Intelligence” personality characteristic is a “Top 5” for user 434 and a “Top 5” for user 436, then the difference value d1 can be weighted by a second weighting value, e.g. 2.8. Alternatively still, if the “Intelligence” personality characteristic is not a “Top 5” for user 434 and not a “Top 5” for user 436, then the difference value d1 can be weighted by a third weighting value, e.g. 1.0. In embodiments, the “Top 5” value can be based on any one or more of the self-review selection, number of user-review selections being above a threshold, and so on.

In one embodiment, the weighted similarity score is determined as:

$$1 - ( \frac{{\sum }_{i = 1}^{n} {( \frac{\vert \begin{matrix}personality characteristic {value}_{A} - \\ personality characteristic {value}_{B}\end{matrix} \vert w}{100} )}_{i}}{n} )$$

where i is the i^{th} adjustable graphical element, n is the number of adjustable graphical elements (e.g. 20) being taken into consideration, and w is a weighting.

For example, assume that the “Intelligence” personality characteristic shown in FIG. 7 is a “Top 5” for user 434 and a “Top 5” for user 436, but the “Interpersonal” personality characteristic shown in FIG. 7 is neither a “Top 5” for user 434 nor a “Top 5” for user 436. Thus the weighted difference value d1 becomes (150×1.4)/200=1.05 and the difference value d2 becomes (30×1)/200=0.15. Adding the determined values and dividing by two yields an average difference of 0.6 or 60%. This equates to a similarity score of 0.4 or 40%, for these two personality characteristics. In this way the “Top 5” personality characteristics are given a proportionally higher emphasis. It will be appreciated that this is a simplified example for only two personality characteristics for purposes of explanation, but the general principle can be ascertained. It will also be appreciated that there exist a number of different ways of performing the calculation. Furthermore, the similarity index could be based on any one or more of the user average, self review and your review scores.

Having described the general methods and apparatus, there is now described embodiments relating to creating a job listing, applying for the job, and using the comparison process to select candidates that have applied.

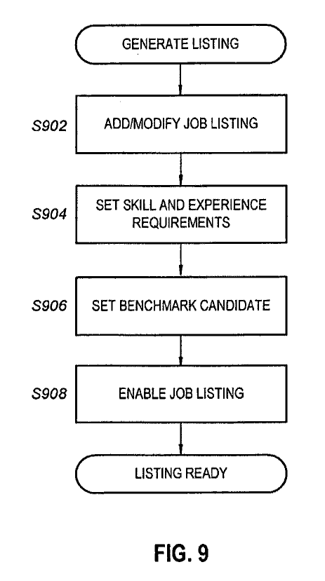

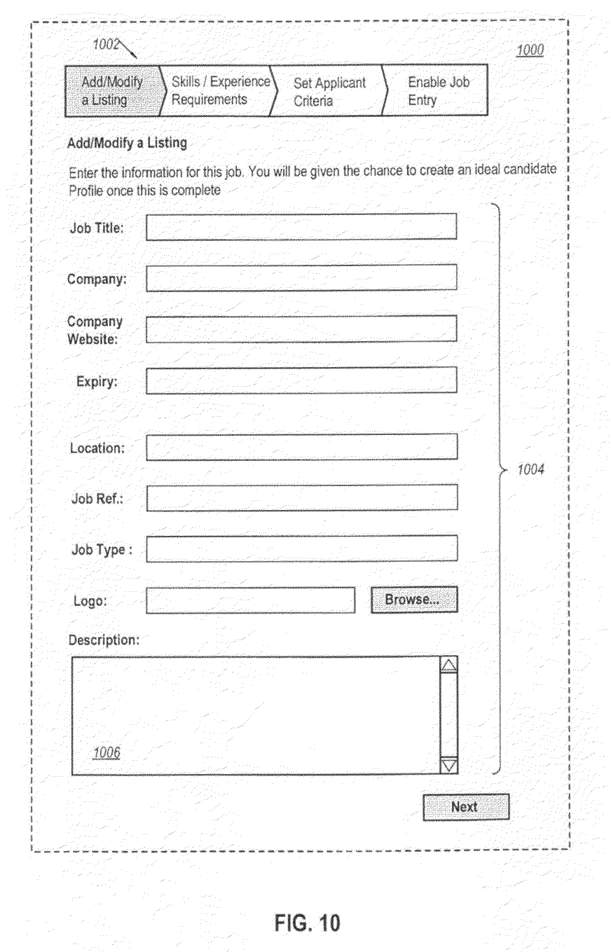

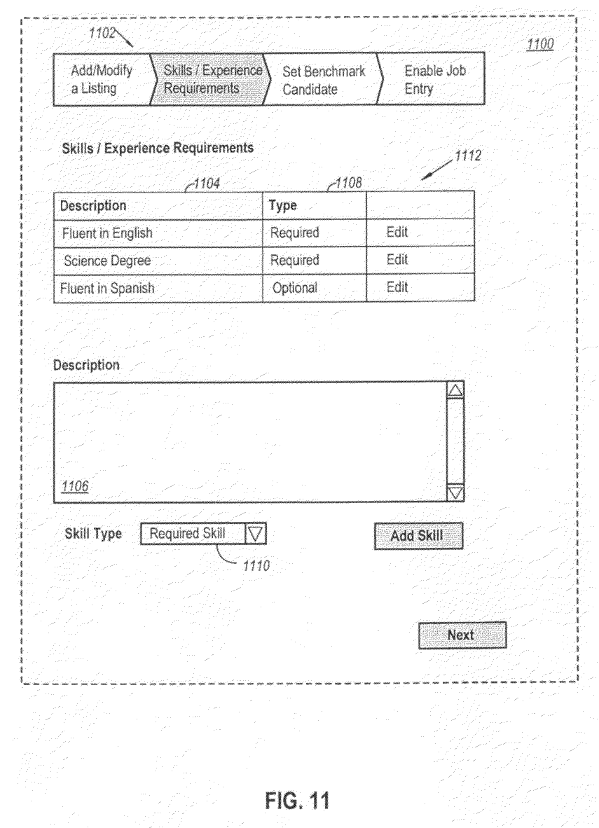

FIG. 9 outlines the process for creating a job listing. In step S902, an employer using a client terminal such as client terminal 112 shown in FIG. 1 submits information about the job. In step S904, the skill and experience requirements for that job are set. This is followed by determining the personality profile of a benchmark candidate (step S906). Finally, in step S908, the job listing is enabled. These steps are described in more detail with reference to FIGS. 10 and 11.

FIG. 10 shows a screen 1000 of a graphical user interface for enabling an employer to post a job listing. The screen of the graphical user interface comprises a progress bar 1002 showing how far along the job creation process the user is, and a set of fields 1004 for entering information about the job (step S902 of FIG. 9). The fields allow information such as the job title, the company offering the job, the website of the company, the job application deadline, the job location, the job reference, and the job type (e.g. part-time or full time), and so on, to be specified. The potential employer can also upload a logo and insert any additional text in text box 1006. The employer then sets the skill and experience requirements (step S904), as shown in FIG. 11, which shows a screen of a graphical user interface 1100 suitable for that purpose. The interface 1100 includes a text box 1106 in which the skill or experience requirements are described, such as “Fluent in English”. From drop-down menu 1100, the employer can indicate whether that skill or experience is required or optional. These then appear in table 1112, which shows the description fields 1104 and type fields 1108.

The employer then creates the personality profile of a benchmark candidate. In embodiments, this is performed substantially like the review process described with reference to FIG. 3. More specifically, the employer can make use of graphical sliders that define different personality characteristics. Alternatively, if there is a user already registered on system 100 that is a suitable candidate (such as an existing employee), the personality profile for that individual can be retrieved. Finally, the job listing is enabled. Billing may also take place at this stage, or at any other stage in the procedure, in accordance with the business model chosen by the system manager. This may include checking the credit account of the potential employer submitting the job listing. The enabled job listing includes a link, unique for the advertisement, for responding to the advertisement. This link takes users to system 100 as described with reference to FIG. 1.

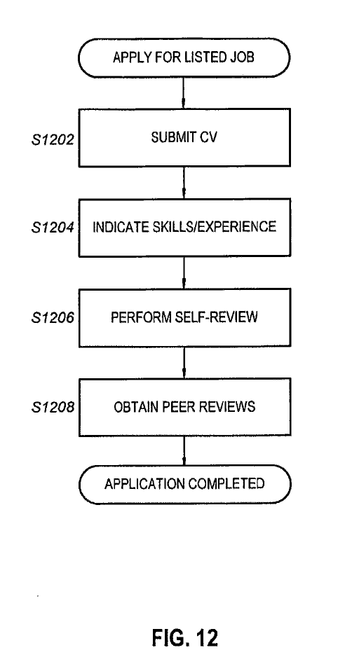

FIG. 12 shows the process of applying for a listed job advertisement by a potential candidate. The process can be performed using client terminal 114, and begins (after clicking on the link), at step S1202, with the candidate electronically submitting his CV or other documents. The candidate then indicates which of the skills and requirements (such as those described with reference to FIG. 11) he possesses. This can be achieved by checking a box next the appropriate field, or in any other suitable manner. The candidate then performs a self-review, which in certain embodiments is substantially like the review process described with reference to FIG. 3. If the candidate is already a registered user of system 100, he can simply load his personality profile from there. Finally, in step S1208, the candidate obtains reviews from his peers. In embodiments, the peer review process is again substantially similar to that described with reference to FIG. 3. Reviewers can be prompted for a review, for example by the candidate entering an email address during the application process. System 100 can then automatically generate and send a request 126, such as an email including a link to system 100, indicating that a review of the candidate is being sought.

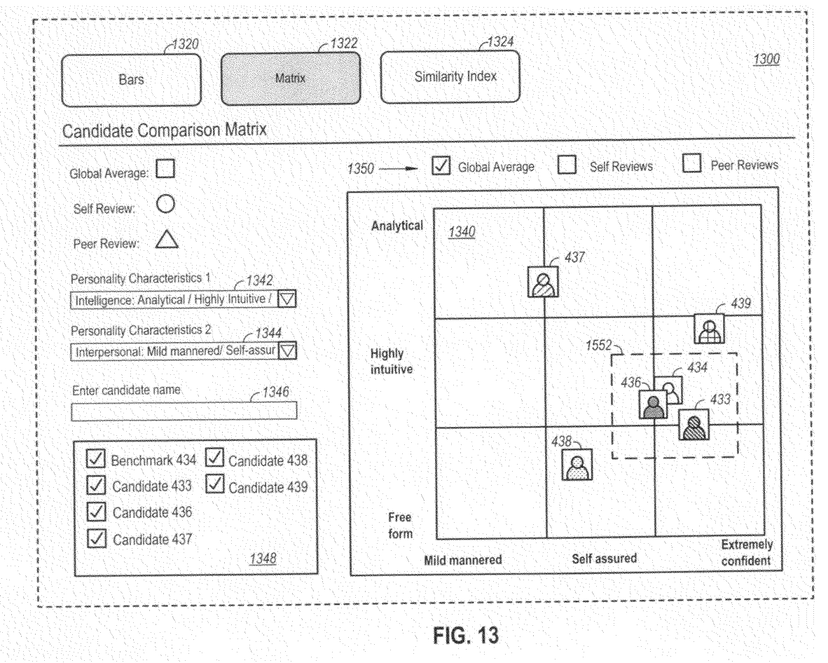

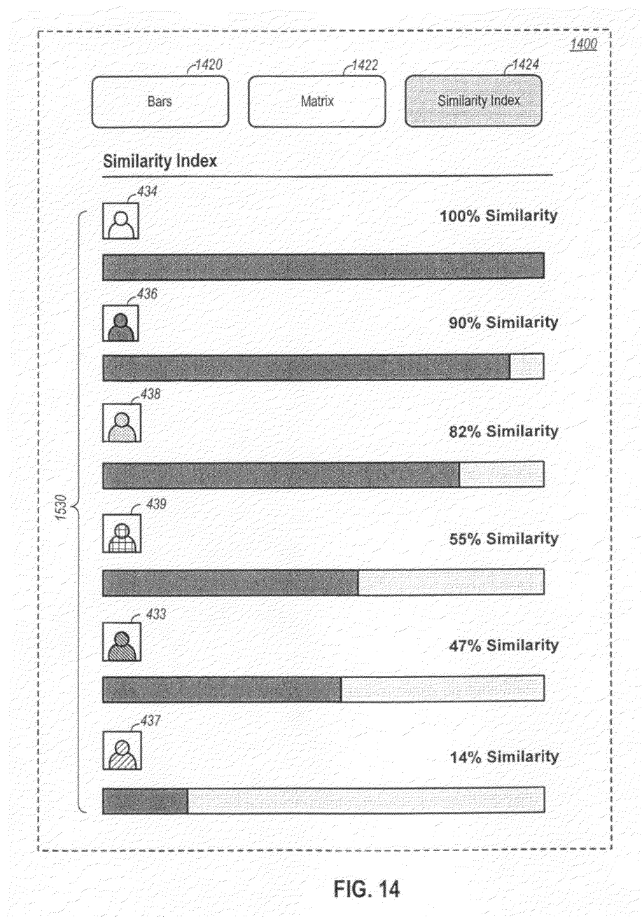

At any time during the lifetime of the job listing, an employer can view the information about the candidates that have applied for the job listing, as will now be described with reference to FIGS. 13 and 14.

FIG. 13 shows a screen 1300 of a display interface for comparing personality profiles. The profiles comprise the profile of the benchmark job candidate 434 and the profiles of the prospective job candidates 433, 436, 437, 438, 439. Here, a comparison for two (sets of) personality characteristics, namely “Analytical”, “Highly intuitive”, “Free form” from the “Intelligence” personality area and “Mild mannered”, “self-assured”, “extremely confident” from the “Interpersonal” area (as for FIG. 5), are shown in matrix form. Other personality characteristics can be selected using the drop-down menus 1342, 1344. As before, users can be added and selected/deselected using fields 1346, 1348. For convenience, only the global average is shown. The global average comprises an average of the inputs from the self-review and the peer reviews. It is envisaged that, where a user is a registered user of system 100, the global average may also take into account input from users that have reviewed a prospective job candidate but have not specifically been asked to provide a review for the job listing in question. Given the potentially large number of prospective job candidates, the interface allows a potential employer to select a sub-area 1552 to be enlarged.

In FIG. 14, a screen 1400 of a graphical user interface showing the similarity score between the personality profile of the benchmark candidate 434 and each of the potential candidates 433, 436, 437, 438, 439 is shown. This can show that, although candidate 433 has similar Intelligence and Interpersonal characteristics for the (sets of) personality characteristics shown in FIG. 13, other personality characteristics (not shown) may be very dissimilar so that his overall similarity score is only 47%.

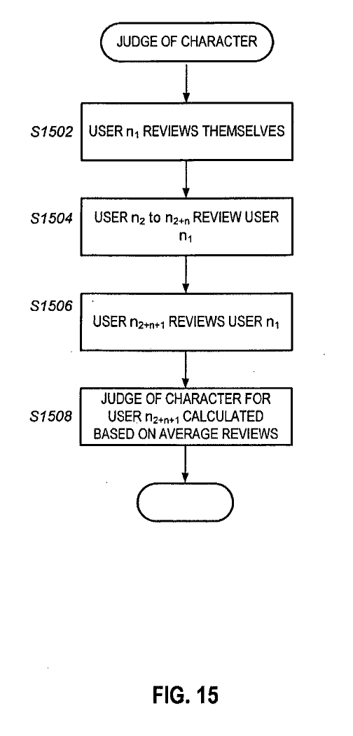

In order to assess whether a reviewer is actually a good judge of character, embodiments provide a process of determining a “judge of character score”, which is an estimate of how well a user can judge someone else's character. The judge of character rating can be used in scenarios where a level of trust is required to determine if individual reviews are accurate by that user and if the users recommendations are correct. For example, businesses and educational institutions can benefit from this algorithm as well as any user that requires a level of trust before making a decision. For example, the application could be used to determine if a users recommendation of another person to perform contractual obligations can be trusted enough to base their decision of contracting that person based on the judge of character rating. The judge of character result is expressed as a percentage calculation out of 100. Where 100% is a perfect judge of character and anything below that represents a lower judge of character. The process is shown in FIG. 15, and begins in step S1502 with a self-review by user n₁. In step S1504, a number of other users (n₂ to n₂₊ₙ) review the first user n₁. When a further user (n₂₊ₙ₊₁) then reviews the first user n₁, a judge of character score for can be calculated based on the previous reviews.

In one embodiment, judge of character for a user is determined as:

$$1 - ( \frac{{\sum }_{i = 1}^{n} {( \frac{\vert \begin{matrix}personality characteristic {value}_{user} - \\ personality characteristic {value}_{average}\end{matrix} \vert w}{100} )}_{i}}{n} )$$

where i is the i^{th} personality characteristic bar and n is the number of bars (e.g. 20) being taken into consideration.

Embodiments described herein can be implemented by software on a general purpose computer or in a combination of software and hardware. Thus any of the ‘means’ defined above can be implemented as code modules in any combination in a computer. Embodiments are particularly suited to implementation as computer software implemented by a network of processing apparatuses. The network can comprise any conventional terrestrial or wireless network. The processing apparatuses can comprise any suitable programmable apparatuses such as a general purpose computer, personal digital assistant, mobile phone (such as a WAP or 3G-compliant phone) and so on. Thus each and every aspect of the embodiments described herein encompasses computer software implemented on a programmable device. The computer software can be provided to the programmable device using any conventional carrier medium. The carrier medium can comprise a transient carrier medium such as an electrical, optical, microwave, acoustic or radio frequency signal carrying the computer code. An example of such a transient medium is a TCP/IP signal carrying computer code over an IP network, such as the Internet. The carrier medium can also comprise storage medium for storing processor readable code such as a floppy disk, hard disk, CD ROM, magnetic tape device or solid state memory device.

Embodiments may be provided in the form of a computer program product on a carrier medium, which may be embodied in a passive storage medium, such as an optical or magnetic medium, or in an electronic medium, such as a mass storage device (e.g. a FLASH memory), or in a hardware device implemented to achieve execution of instructions, such as ASIC, an FPGA, a DSP or the like. Alternatively, the carrier medium can comprise a signal carrying the computer program code such as an optical signal, an electrical signal, an electromagnetic signal, an acoustic signal or a magnetic signal. For example, the signal can comprise a TCP/IP signal carrying the code over the Internet.

Although in foregoing embodiments the system and methods are described in the context of employee recruitment, other applications in which personality profiles are used are envisaged, such as dating sites. As such, it will be appreciated that embodiments are not limited to the exemplary personality characteristics described above or even to personality characteristics.

As used herein the term “characteristic” generally refers to any trait, property, quality and/or feature of a person or subject matter of interest, so that reviews of products, places and things are also contemplated. Thus, in certain embodiments, a user may select highly-rated traits, properties, qualities and/or features of products, places and/or things, and each of the traits, properties, qualities and/or features may be divided into subsets, each subset representing a higher-order trait, property, quality and/or feature.

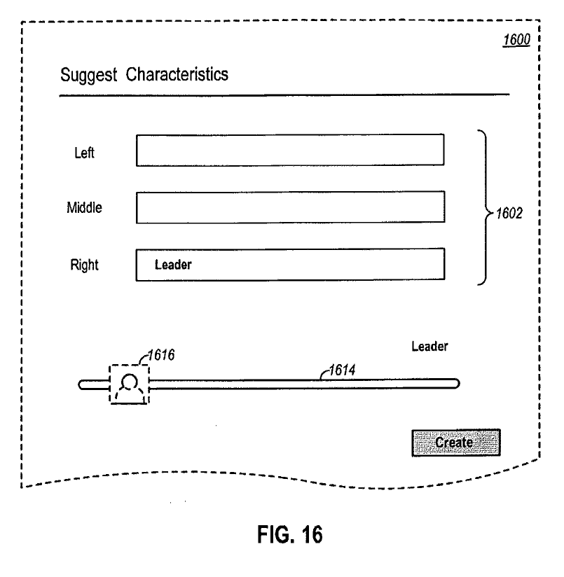

Although in foregoing embodiments the personality characteristics are predetermined, characteristics can be replaced and/or complemented with other characteristics that have been suggested by employers or individual users. An example of a screen 1600 showing how this can be implemented is shown in FIG. 16, and includes a set of text fields 1602 for allowing a user to enter the characteristics of their choice for an adjustable graphical element. In the example shown in FIG. 16, three text fields (labelled “Left”, “Middle” and “Right”) are provided corresponding to the positioning of the three characteristics with respect to the adjustable graphical element that is to be shown—the screen may thus include a preview of the adjustable graphical element comprising a track 1614 and a slider button 1616. Screen 1600 (or another screen) may also allow a user to view characteristics suggested by another user and to vote for, or indicate their approval of, such user-suggested characteristics (not shown). User-suggested personality characteristics can be displayed according to popularity or most recent additions. In this context, a user may be an individual or an employer. In one embodiment, the characteristics suggested by individuals must be approved, for example by a provider of system 100, before they are available for display to other individuals. However, this need not be the case for an employer who is using the system 100 to post a particular job listing or using the system 100 internally (e.g. for purposes of employee management and development). Thus in one embodiment, system 100 can be an internal system of a company. In such an internal system, personality profiles of employees may be tagged or labelled, for example according to department, group or other attribute. This allows an employer to compare personality profiles having similar and/or different attributes, e.g. within groups or between groups.

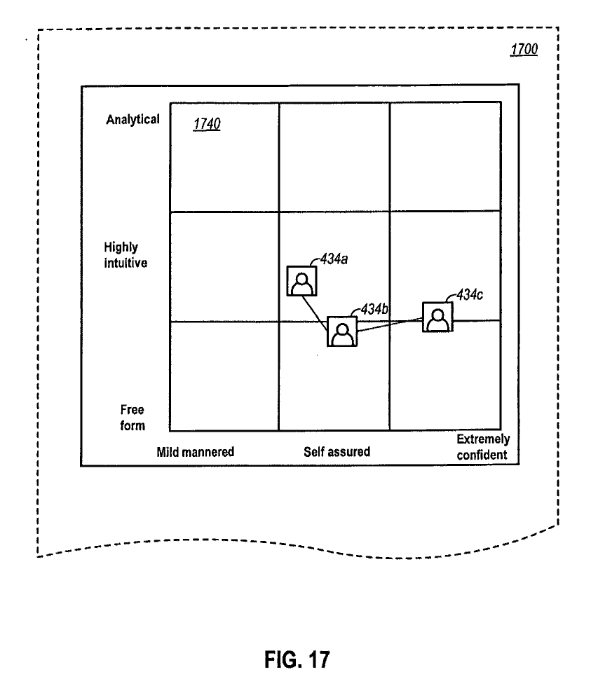

Although in foregoing embodiments the personality characteristic values are averaged over all of the user reviews (“User Average”), in other embodiments the values can be based on a sub-set of user reviews. For example, in order to track employee development over time, the values can correspond to a particular time period. For example, with reference to FIG. 17, which shows a screen 1700 for comparison of personality profiles using the matrix form 1740 as described with reference to FIG. 5 (certain elements of which not shown here for reasons of clarity), the values for user 434 for three periods of time are shown. These are represented as icons 424a, 434b and 434c. For example, the time periods can correspond to the years of employment, such as the first two years of employment (424a), the second to fourth years of employment (434b), and the fourth to sixth years of employment (434c). As employee 434 is appraised over time his values may change as shown. As in foregoing embodiments, personality characteristics can be selected from drop-down menus, and individuals can be searched for and selected (or deselected). Furthermore, different time periods can be selected. For purposes of clarity, only one employee is shown.

Although in foregoing embodiments users can connect directly to system 100, in other embodiments a third party website, such as a social networking website, may include an application for reviewing users. Furthermore, a user's profile of the social networking website may include his personality profile. For example, in the case of a product the profile may be part of a seller website. This also means that a reviewer need not necessarily register with system 100, but can simply review a user by means of the social networking website.

Although in foregoing embodiments the judge of character and similarity index scores are expressed as percentages, it will be appreciated that there are other ways of presenting the information, such as a ‘star’ rating system. Thus the similarity index can be qualitative or quantitative.

It is to be appreciated that the Detailed Description section, and not the Summary and Abstract sections, is intended to be used to interpret the claims. The Summary and Abstract sections may set forth one or more but not all exemplary embodiments as contemplated by the inventor(s), and thus, are not intended to limit the scope of the appended claims in any way.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by those skilled in the art in light of the teachings and guidance.

The breadth and scope of the present invention should not be limited by any of the above-described exemplary embodiments, but should be defined only in accordance with the following claims and their equivalents.

1. A computer-implemented method of facilitating reviewing of a person's personality, the method comprising:
displaying, on a display of a client computer, a graphical user interface comprising a plurality of adjustable graphical elements, each of the adjustable graphical elements representing a plurality of personality characteristics, each of the adjustable graphical elements being adjustable to one of a plurality of different positions, each of the positions corresponding to a value of the respective plurality of personality characteristics.

2. The method of claim 1, wherein the adjustable graphical elements comprise movable elements slidable on fixed elements.

3. The method of claim 1, further comprising disabling or hiding display of the values corresponding to the plurality of different positions in the graphical user interface.

4. The method of claim 1, wherein the graphical user interface comprises selectable elements that enable a user of the client computer to select a subset of the plurality of personality characteristics represented by the plurality of adjustable graphical elements as highly-rated personality characteristics of the person.

5. The method of claim 1, wherein the graphical user interface comprises a plurality of pages, each page containing a subset of said plurality of adjustable graphical elements.

6. The method of claim 5, wherein the graphical user interface comprises a plurality of tabs corresponding to the plurality of pages, said tabs being selectable by a user, wherein selection of one of the tabs by the user causes the graphical user interface to display the corresponding page.

7. The method of claim 5, wherein each subset represents a higher-order personality characteristic that encompasses the plurality of personality characteristics represented by the plurality of adjustable graphical elements of the subset.

8. A computer-implemented method of facilitating reviewing of a person's personality, the method comprising:
transmitting, by a server computer to a client computer over a network, a graphical user interface for display at the client computer, the graphical user interface comprising a plurality of adjustable graphical elements, each of the adjustable graphical elements representing a plurality of personality characteristics, each of the adjustable graphical elements being adjustable to one of a plurality of different positions, each of the positions corresponding to a value of the respective plurality of personality characteristics.

9. The method of claim 8, wherein the adjustable graphical elements comprise movable elements slidable on fixed elements.

10. The method of claim 8, further comprising disabling or hiding display of the values corresponding to the plurality of different positions in the graphical user interface.

11. The method of claim 8, wherein the graphical user interface comprises selectable elements that enable a user of the client computer to select a subset of the plurality of personality characteristics represented by the plurality of adjustable graphical elements as highly-rated personality characteristics of the person.

12. The method of claim 8, wherein the graphical user interface comprises a plurality of pages, each page containing a subset of said plurality of adjustable graphical elements.

13. The method of claim 12, wherein the graphical user interface comprises a plurality of tabs corresponding to the plurality of pages, said tabs being selectable by a user, wherein selection of one of the tabs by the user causes the graphical user interface to display the corresponding page.

14. The method of claim 12, wherein each subset represents a higher-order personality characteristic that encompasses the plurality of personality characteristics represented by the plurality of adjustable graphical elements of the subset.

15. A computer-implemented method of comparing personality profiles, the method comprising:
processing, by a computer processor, data values of first and second ones of personality profiles to obtain an overall similarity score, each of the personality profiles defined by a plurality of data values, each of the data values representing a plurality of personality characteristics, the processing including determining the differences between respective data values of the first and second personality profiles.

16. The method of claim 15, wherein each of the personality profiles includes information indicating a subset of the plurality of data values that represent highly-rated personality characteristics, and wherein determining the differences between respective data values includes weighting the differences in accordance with the information.

17. The method of claim 16, wherein weighting the differences comprises:
applying a first weight to the difference between respective ones of the data values, if both of said respective ones of the data values are members of the subsets of the corresponding personality profiles; and
applying a second weight to the difference between respective ones of the data values, if only one of said respective ones of the data values is a member of the subset of the corresponding personality profile.

18. The method of claim 15, wherein one of the personality profiles comprises a personality profile for a benchmark job applicant.

19. A client computer, comprising:
a display;
a network interface configured to connect the client computer to a network;
a processor;
a memory operatively coupled to the processor, the memory comprising executable instructions which, when executed by the processor, cause the client computer to display a graphical user interface received from a server computer over the network, the graphical user interface comprising a plurality of adjustable graphical elements, each of the adjustable graphical elements representing a plurality of different personality characteristics, each of the adjustable graphical elements being adjustable to one of a plurality of different positions, each of the positions corresponding to a value of the respective plurality of different personality characteristics.

20. The client computer of claim 19, wherein the adjustable graphical elements comprise movable elements slidable on fixed elements.

21. The client computer of claim 19, further comprising disabling or hiding display of the values corresponding to the plurality of different positions in the graphical user interface.

22. The client computer of claim 19, wherein the graphical user interface comprises selectable elements that enable a user of the client computer to select a subset of the plurality of different personality characteristics represented by the plurality of adjustable graphical elements as highly-rated personality characteristics of the person.

23. The client computer of claim 19, wherein the graphical user interface comprises a plurality of pages, each page containing a subset of said plurality of adjustable graphical elements.

24. The client computer of claim 23, wherein the graphical user interface comprises a plurality of tabs corresponding to the plurality of pages, said tabs being selectable by a user, wherein selection of one of the tabs by the user causes the graphical user interface to display the corresponding page.

25. The client computer of claim 23, wherein each subset represents a higher-order personality characteristic that encompasses the plurality of different personality characteristics represented by the plurality of adjustable graphical elements of the subset.

26. A server computer, comprising:
a network interface configured to connect the server computer to a network;
a processor;
a memory operatively coupled to the processor, the memory comprising executable instructions which, when executed by the processor, cause the server computer to transmit a graphical user interface to the client computer over the network, the graphical user interface comprising a plurality of adjustable graphical elements, each of the adjustable graphical elements representing a plurality of different personality characteristics, each of the adjustable graphical elements being adjustable to one of a plurality of different positions, each of the positions corresponding to a value of the respective plurality of different personality characteristics.

27. The server computer of claim 26, wherein the adjustable graphical elements comprise movable elements slidable on fixed elements.

28. The server computer of claim 26, further comprising disabling or hiding display of the values corresponding to the plurality of different positions in the graphical user interface.

29. The server computer of claim 26, wherein the graphical user interface comprises selectable elements that enable a user of the client computer to select a subset of the plurality of different personality characteristics represented by the plurality of adjustable graphical elements as highly-rated personality characteristics of the person.

30. The server computer of claim 26, wherein the graphical user interface comprises a plurality of pages, each page containing a subset of said plurality of adjustable graphical elements.

31. The server computer of claim 30, wherein the graphical user interface comprises a plurality of tabs corresponding to the plurality of pages, said tabs being selectable by a user, wherein selection of one of the tabs by the user causes the graphical user interface to display the corresponding page.

32. The server computer of claim 30, wherein each subset represents a higher-order personality characteristic that encompasses the plurality of different personality characteristics represented by the plurality of adjustable graphical elements of the subset.

33. A computer-implemented method of facilitating reviewing of an entity, the method comprising:
displaying, on a display of a client computer, a graphical user interface comprising a plurality of adjustable graphical elements, each of the adjustable graphical elements representing a plurality of attributes of the entity, each of the adjustable graphical elements being adjustable to one of a plurality of different positions, each of the positions corresponding to a value of the respective plurality of attributes.

34. A computer-implemented method of facilitating reviewing of an entity, the method comprising:
transmitting, by a server computer to a client computer over a network, a graphical user interface for display at the client computer, the graphical user interface comprising a plurality of adjustable graphical elements, each of the adjustable graphical elements representing a plurality of attributes of the entity, each of the adjustable graphical elements being adjustable to one of a plurality of different positions, each of the positions corresponding to a value of the respective plurality of attributes.

35. A computer-implemented method of comparing entity profiles, the method comprising:
processing, by a computer processor, data values of first and second ones of attributes of an entity to obtain an overall similarity score, each of the entity profiles defined by a plurality of data values, each of the data values representing a plurality of attributes, the processing including determining the differences between respective data values of the first and second entity profiles.

36. A client computer, comprising:
a display;
a network interface configured to connect the client computer to a network;
a processor;
a memory operatively coupled to the processor, the memory comprising executable instructions which, when executed by the processor, cause the client computer to display a graphical user interface received from a server computer over the network, the graphical user interface comprising a plurality of adjustable graphical elements, each of the adjustable graphical elements representing a plurality of different attributes of an entity, each of the adjustable graphical elements being adjustable to one of a plurality of different positions, each of the positions corresponding to a value of the respective plurality of different attributes.

37. A server computer, comprising:
a network interface configured to connect the server computer to a network;
a processor;
a memory operatively coupled to the processor, the memory comprising executable instructions which, when executed by the processor, cause the server computer to transmit a graphical user interface to the client computer over the network, the graphical user interface comprising a plurality of adjustable graphical elements, each of the adjustable graphical elements representing a plurality of different attributes of an entity, each of the adjustable graphical elements being adjustable to one of a plurality of different positions, each of the positions corresponding to a value of the respective plurality of different attributes.

38. The server of claim 37, wherein the attributes are customizable.

39. A client computer, comprising:
display means;
network interface means configured to connect the client computer to a network;
processor means;
memory means operatively coupled to the processor means, the memory means comprising executable instructions which, when executed by the processor means, cause the client computer to display a graphical user interface received from a server computer over the network, the graphical user interface comprising a plurality of adjustable graphical elements, each of the adjustable graphical elements representing a plurality of different personality characteristics, each of the adjustable graphical elements being adjustable to one of a plurality of different positions, each of the positions corresponding to a value of the respective plurality of different personality characteristics.

40. A server computer, comprising:
network interface means configured to connect the server computer to a network;
processor means;
memory means operatively coupled to the processor means, the memory means comprising executable instructions which, when executed by the processor means, cause the server computer to transmit a graphical user interface to the client computer over the network, the graphical user interface comprising a plurality of adjustable graphical elements, each of the adjustable graphical elements representing a plurality of different personality characteristics, each of the adjustable graphical elements being adjustable to one of a plurality of different positions, each of the positions corresponding to a value of the respective plurality of different personality characteristics.

41. A computer-readable medium having stored thereon computer-executable instructions that, if executed by a computing device, cause the computing device to display a graphical user interface, the graphical user interface comprising a plurality of adjustable graphical elements, each of the adjustable graphical elements representing a plurality of different personality characteristics, each of the adjustable graphical elements being adjustable to one of a plurality of different positions, each of the positions corresponding to a value of the respective plurality of different personality characteristics.
